(19) United States
(12) Patent Application Publication
(10) Pub. No.: US 2010/0125878 A1
(43) Pub. Date: May 20, 2010

(54) EMBEDDED WIRELESS ANTENNA FOR NETWORK TV

(75) Inventors: Xiangpeng Jing, San Diego, CA (US); Aixin Liu, San Diego, CA (US); Djung Nguyen, San Diego, CA (US); Abhishek Patil, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/273,771

(22) Filed: Nov. 19, 2008

(51) Int. Cl. H04N 7/18; H04N 5/66

(52) U.S. Cl. 725/81; 348/739

(57) ABSTRACT

A WiFi chipset is integrated into a TV chassis as are wireless audio-video signal antennas that feed the chipset. The TV processor causes signals from home network components received through the antennas and chipset to be displayed on the TV.

### I. FIELD OF THE INVENTION

The present invention relates generally to embedded wireless modules (chipsets) and associated antennas for network TVs.

### II. BACKGROUND OF THE INVENTION

Home networks are provided in which information including multimedia is shared among networked components. For example, a TV might access a disk player or central server to play multimedia programming stored on disk or at the server. The TV might also access a hard disk drive to play recorded TV programming, display digital photographs, etc.

TVs also evolve, and presently relatively large flat panel display TVs can be mounted on walls as beautiful pieces of art work in which unsightly wires (network cables, video cables, etc.) are removed from view. This is often accomplished using wireless technology, wherein TVs wirelessly receive multimedia information from other components in the network.

As understood herein, relatively large wireless bandwidth is required to transfer multimedia information in a home network. For instance, compressed high definition (HD) video requires between twenty and fifty megabits per second of bandwidth.

As also understood herein, current wireless adapters for TVs such as universal serial bus (USB) adapters typically require the host CPU to process the wireless protocol, which greatly lowers both the TV and wireless performance, due to the limited processing capability of the TV CPU and its high application load. Although some USB adapters offload the wireless processing, the USB driver that must be executed by the TV processor still consumes a great amount of processing capacity in the TV. Still further, such adapters often result in poor reception because the adapter must be plugged in behind the TV, reducing received wireless signal strength. Furthermore, the customer must install the electrical connections behind the TV and mount the antennas on the TV, which is not only inconvenient but which also may result in unsightly appearance as well as poor wireless performance.

### SUMMARY OF THE INVENTION

Accordingly, a TV includes a chassis, a TV display on the chassis, and a TV signal processing board supported on the chassis. A wireless module is on the signal processing board and likewise a TV processor is on the signal processing board in communication with the wireless module using, e.g., standard communication buses. Network applications in the TV can stream audio and video as well as transfer data using the wireless module from a home network or the Internet. Additionally, a TV tuner receives TV signals from a TV signal source. As set forth further below, at least one antenna element is inside the chassis and sends the audio-video signals, which are received from a home network, to the wireless module, as well as, if desired, sending audio and/or video and/or non-audio/video data back to the network. The wireless module and antenna can be configured for, e.g., WiFi, Bluetooth, etc.

In example embodiments a bezel surrounds the chassis and a display shield is in the chassis and is disposed between the TV display and the signal processing board. The display shield defines an outer periphery, and the antenna element is juxtaposed with the bezel beyond the outer periphery of the display shield. In some implementations an electrical lead connecting the antenna element to the wireless module is also juxtaposed with the bezel beyond the outer periphery of the display shield.

In example implementations at least first and second antenna elements are provided, with the first antenna element being disposed parallel to a first edge of the chassis and the second antenna element being disposed parallel to a second, perpendicular edge of the chassis.

In example embodiments the signal processing board defines first through fourth edges respectively facing first through fourth edges of the chassis. The TV tuner can be juxtaposed with the third and fourth edges of the signal processing board and the antenna elements can be juxtaposed with the first and second edges of the chassis, i.e., opposite the tuner relative to the signal processing board.

In another aspect, an apparatus has a wireless chipset integrated into a TV chassis. At least one wireless antenna element is in the chassis for feeding the chipset. A TV processor in the chassis causes signals from home network components received through the antenna and chipset to be displayed on the TV.

In another aspect, a system is disclosed for facilitating presentation, on a TV in a home network, audio-video content wirelessly received from the home network without requiring antenna wires extending outside the TV to receive the content. The system includes means for displaying video content and means for holding the means for displaying. Antenna means are inside the means for holding and are configured for wirelessly receiving the audio-video content from the home network.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of the front of a wall-mounted flat panel TV, showing network components schematically; and

FIG. 2 is a rear elevation view of the rear of an example embodiment of the TV with the outer skin removed to expose internal components.

### DETAILED DESCRIPTION OF THE PREFERRED EMBODIMENT

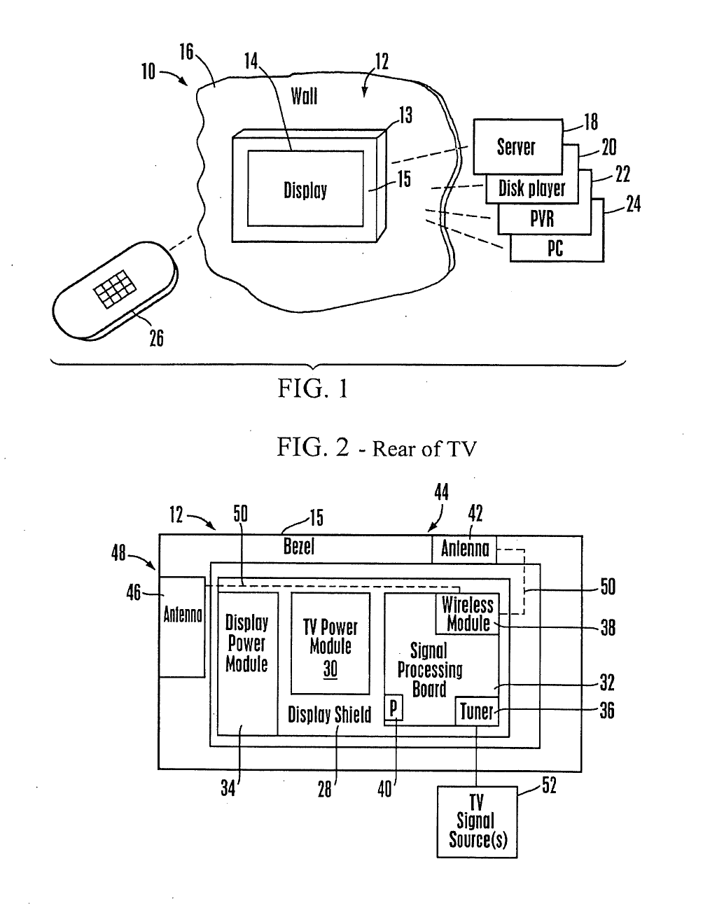

Referring initially to FIG. 1, a home network 10 may include one more TVs 12 (only a single TV shown) with a TV chassis 13 holding a TV display 14. Typically, a plastic frame-like bezel 15 frames the display 14.

A TV 12 may be mounted by means known in the art on a surface 16 of a dwelling, such as a wall or ceiling. The TV 12 may be an analog and/or digital TV with a flat panel (matrix-type) standard definition and/or high definition (HD) display 14, although other types of displays may be used.

The network 10 may include various components that communicate audio-video information wirelessly to the TV 12 using, e.g., WiFi principles, Bluetooth principles, or other wireless principles known in the art. For example, the TV 12 may receive compressed or uncompressed HD video from a computer server 18, a disk player 20, a personal video recorder (PVR) 22, and a personal computer (PC) 24, as well as other information such as digital photographs for display on the TV 12. Other network components such as game players or indeed other TVs may be provided in the network 10. A hand-held remote control device 26 may be manipulated by a person to input wireless command signals to the TV 12 and/or to various network components in accordance with principles known in the art.

Now referring to FIG. 2, the rear of an example embodiment of the TV 12 (with any outer skin or covering removed) is shown. A metal display shield 28 such as a liquid crystal display (LCD) shield typically is registered with the display 14 to be generally flush therewith, to shield the display elements of the display 14 from interference that might be generated by the components on the opposite side of the shield 28 from the display 14. As divulged in more detail below, it is desirable that the antennas are disposed away from the metal display shield for improved reception.

Among the shielded components alluded to above can be a TV power module 30 for powering the TV and a TV signal processing board 32 for holding sub-components. Both the TV power module 30 and TV signal processing board 32 typically are mounted to the shield 28. A display power inverter 34 may also be mounted on the shield 28 for purposes known in the art of, e.g., LCD displays.

The TV signal processing board 32 may hold, among other things, a TV tuner 36 and a wireless module 38 such as but not limited to an 802.11a/b/g/n chipset made by Broadcom, Marvell, Atheros, or Ralink with a peripheral component interconnect (PCI) or PCI express form factor (e.g., Ralink 2880) and which consequently may communicate with a TV processor 40 on the signal processing board over a mini PCI bus or PCI express bus or other appropriate communication buses. Also, the wireless module 38 may further include a Bluetooth transceiver, in which case such a combination chipset may assume a secure digital input/output (SDIO) form factor and communicate with the TV processor 40 over an SDIO bus or a USB bus. To reduce the processing load on the TV (host) processor, wireless modules that have the capability to offload processing onto the wireless chipset are preferred. Such processing offloading chipsets place very little load on the host processor.

As shown in FIG. 2, one or more wireless antenna elements may be included within the TV 12. For example, a first elongated antenna element 42 may be disposed near a top edge 44 of the TV 12 and parallel thereto (i.e., horizontally), while a second elongated antenna element 46 may be disposed near a left edge 48 (or right edge) of the TV 12 and parallel thereto (i.e., vertically). In the example embodiment shown, the antenna elements 42, 46 are disposed between the edges of the display shield 28 and the plastic bezel 15 that frames the TV, and may be co-planar with the bezel as shown. Furthermore, in the example shown when the tuner 36 is mounted near one set of edges of the signal processing board 32, in this case, near the right and bottom edges, the antenna elements 42, 46 are mounted near opposite counterpart edges the TV 12, in this case, near the top and left edges of the TV 12.

The antenna elements 42, 46 may be dual-band multiple input-multiple output (MIMO) antenna elements that are configured for reception of 2.4 GHz signals and 5 GHz signals. Furthermore, as can be appreciated from the dashed line 50, connecting wires from the antenna elements 42, 46 (only the line from the first antenna 46 shown) to the wireless module 38 may be routed in the space between the outer edges of the shield 28 and the bezel 15. To reduce the radiofrequency signal loss of antenna extension cables, a bus extension cable (when using USB) can be used to extend the wireless module closer to the antenna.

With the above in mind, the present invention recognizes that a MIMO antenna may be implemented in separate antenna elements, and it can be advantageous to separate the locations of those elements for diversity gain (a benefit of 802.11n using MIMO technology). The antenna element placement and positioning shown in FIG. 2 can produce optimal reception and diversity and minimize interference to the TV tuner 36. Also, mounting the antenna elements inside the plastic bezels at the edge and outside the metal shield can produce improved reception, it being understood that the exact antenna positions can be determined based on different TV model configurations. The lines 50 connecting the antenna elements to the wireless module may be mini coaxial cables (with Hirose U.FL type connectors) to minimize signal loss and they can be wired along the edge of the TV inside the bezels as shown to promote network performance.

In non-limiting implementations a SDIO controller may be included, e.g., on the signal processing board 32 to allow the TV 12 to access a secure digital media card (not shown) to display photos or other media. Without limitation, the wireless module 38 may be implemented by a USB WiFi with the capability to offload certain CPU functions. For example, a Broadcom 4323 chip may be used.

Completing the description of FIG. 2, in addition to communicating audio, video, and data with the home network through the antennas 42, 46 and wireless module 38, the TV 12 receives, through the TV tuner 36, TV signals from a source 52 of TV programming such as a set-top box, a cable TV source, a satellite TV receiver, a conventional terrestrial TV broadcast antenna, etc.

While the particular EMBEDDED WIRELESS ANTENNA FOR NETWORK TV is herein shown and described in detail, it is to be understood that the subject matter which is encompassed by the present invention is limited only by the claims.

What is claimed is:

1. TV comprising:
a chassis;
a TV display on the chassis;
a TV signal processing board supported on the chassis;
a wireless module on the signal processing board configured to receive at least audio and video signals;
a TV processor on the signal processing board and communicating with the wireless module, the audio-video signals being presentable on the TV display under the control of the TV processor;
a TV tuner receiving TV signals from a TV signal source; and
at least one antenna element inside the chassis and sending at least audio and video signals received from a home network to the wireless module.

2. The TV of claim 1, comprising a bezel surrounding the chassis and a display shield in the chassis and disposed between the TV display and the signal processing board, the display shield defining an outer periphery, the antenna element being juxtaposed with the bezel beyond the outer periphery of the display shield.

3. The TV of claim 2, wherein an electrical lead connecting the antenna element to the wireless module is disposed between the bezel and the outer periphery of the display shield.

4. The TV of claim 1, comprising at least first and second antenna elements, the first antenna element being disposed parallel to a first edge of the chassis and the second antenna element being disposed parallel to a second edge of the chassis, the first and second edges being substantially perpendicular to each other.

5. The TV of claim 1, comprising at least first and second antenna elements, wherein the signal processing board defines first through fourth edges respectively facing first through fourth edges of the chassis, the TV tuner being juxtaposed with the third and fourth edges of the signal processing board, the antenna elements being juxtaposed with the first and second edges of the chassis.

6. Apparatus, comprising:
wireless chipset integrated into a TV chassis;
at least one wireless audio-video signal antenna element in the chassis and feeding the chipset; and
TV processor in the chassis causing signals from home network components received through the antenna and chipset to be displayed on the TV.

7. The apparatus of claim 6, wherein the chipset is a WiFi chipset.

8. The apparatus of claim 6, further comprising a TV tuner in the chassis receiving TV signals from a source of TV signals.

9. The apparatus of claim 6, further comprising:
a TV signal processing board supported on the chassis, the chipset and TV processor being mounted on the signal processing board.

10. The apparatus of claim 9, comprising a bezel surrounding the chassis and a display shield in the chassis and disposed between a TV display and the signal processing board, the display shield defining an outer periphery, the antenna element being juxtaposed with the bezel beyond the outer periphery of the display shield.

11. The apparatus of claim 10, wherein an electrical lead connecting the antenna element to the chipset is juxtaposed with the bezel beyond the outer periphery of the display shield.

12. The apparatus of claim 6, comprising at least first and second antenna elements, the first antenna element being disposed parallel to a first edge of the chassis and the second antenna element being disposed parallel to a second edge of the chassis, the first and second edges being substantially perpendicular to each other.

13. The apparatus of claim 9, comprising at least first and second antenna elements, wherein the signal processing board defines first through fourth edges respectively facing first through fourth edges of the chassis, a TV tuner being juxtaposed with the third and fourth edges of the signal processing board, the antenna elements being juxtaposed with the first and second edges of the chassis.

14. System for facilitating presentation on a TV in a home network audio-video content wirelessly received from the home network without requiring antenna wires extending outside the TV to receive the content, comprising:
means for displaying video content;
means for holding the means for displaying; and
antenna means inside the means for holding and configured for wirelessly receiving the audio-video content from the home network.

15. The system of claim 14, wherein the antenna means includes at least one antenna element, the means for holding includes a TV chassis, and the means for displaying includes a TV display.

16. The system of claim 15, comprising:
a TV signal processing board supported on the TV chassis;
a wireless module on the signal processing board receiving signals from the antenna element;
a TV processor on the signal processing board and communicating with the wireless module; and
a TV tuner receiving TV signals from a TV signal source.

17. The system of claim 16, comprising a bezel surrounding the chassis and a display shield in the chassis and disposed between the TV display and the signal processing board, the display shield defining an outer periphery, the antenna element being located at the bezel and distanced from the outer periphery of the display shield.

18. The system of claim 17, wherein an electrical lead connecting the antenna element to the wireless module is juxtaposed with the bezel and distanced from the outer periphery of the display shield.

19. The system of claim 16, comprising at least first and second antenna elements, the first antenna element being disposed parallel to a first edge of the chassis and the second antenna element being disposed parallel to a second edge of the chassis, the first and second edges being substantially perpendicular to each other.

20. The system of claim 16, comprising at least first and second antenna elements, wherein the signal processing board defines first through fourth edges respectively facing first through fourth edges of the chassis, the TV tuner being juxtaposed with the third and fourth edges of the signal processing board, the antenna elements being juxtaposed with the first and second edges of the chassis.
